(19) United States
(12) Patent Application Publication
(10) Pub. No.: US 2012/0013607 A1
(43) Pub. Date: Jan. 19, 2012

(54) APPARATUS AND METHOD OF GENERATING THREE-DIMENSIONAL MOUSE POINTER

(75) Inventor: Hyun-seok LEE, Seoul (KR)

(73) Assignee: Samsung Electronics Co., Ltd, Suwon-si (KR)

(21) Appl. No.: 13/106,079

(22) Filed: May 12, 2011

(30) Foreign Application Priority Data
Jul. 19, 2010 (KR) 10-2010-0069424

(51) Int. Cl. G06T 15/00

(52) U.S. Cl. 345/419

(57) ABSTRACT

A method of generating a mouse pointer which has a predetermined depth within a three-dimensional (3D) image includes extracting depth information of at least one object of a 3D image, determining a location of a mouse pointer within the 3D image, and processing the mouse pointer to have a predetermined depth in the determined location by using the extracted depth information. Accordingly, a user enjoys an enhanced 3D effect by generating and displaying a mouse pointer having a predetermined depth in a location of the changed mouse pointer if the location of the mouse pointer is changed by using a pointing unit.

### CROSS-REFERENCE TO RELATED APPLICATIONS

This application claims the benefit of priority from Korean Patent Application No. 10-2010-0069424, filed on Jul. 19, 2010 in the Korean Intellectual Property Office, the disclosure of which is incorporated herein by reference in its entirety.

### BACKGROUND

1. Field of the Invention

Apparatuses and methods consistent with the exemplary embodiments relate to an apparatus and a method of generating a three-dimensional mouse pointer, and more particularly, to an apparatus and a method of generating a mouse pointer which has a predetermined depth within a three-dimensional image space.

2. Description of the Related Art

Objects which are included in a conventional three-dimensional (3D) image have a depth while a mouse pointer which points one of such objects has a two-dimensional (2D) coordinate value without any depth.

Accordingly, there is a necessity to express a mouse pointer having a predetermined depth within a 3D image space for a user to enjoy an enhanced 3D effect.

### SUMMARY

Accordingly, one or more exemplary embodiments provide an apparatus and a method for generating a mouse pointer which has a predetermined depth within a three-dimensional image space.

Additional aspects and utilities of the present general inventive concept will be set forth in part in the description which follows and, in part, will be obvious from the description, or may be learned by practice of the present general inventive concept.

The foregoing and/or other aspects may be achieved by providing a method of generating a mouse pointer which has a predetermined depth within a three-dimensional (3D) image, the method including extracting depth information of at least one object of a 3D image, determining a location of a mouse pointer within the 3D image, and processing the mouse pointer to have a predetermined depth in the determined location by using the extracted depth information.

The method may further include converting the mouse pointer into a 3D mouse pointer.

The method may further include generating a depth map of the at least one object within a 3D image space based on the extracted depth information.

The generated depth map may include a plurality of depth levels, and the processing the depth of the mouse pointer may include selecting one of the plurality of depth levels corresponding to the determined location of the mouse pointer and processing the mouse pointer to have a depth corresponding to the selected depth level.

The processing the depth of the mouse pointer may include processing the mouse pointer to have the predetermined depth by adjusting a size of the mouse pointer.

The method may further include rendering the mouse pointer which is processed to have the predetermined depth.

The converting the mouse pointer may further include converting a location or a direction of the mouse pointer corresponding to a changed viewing angle of a camera if the viewing angle of the camera of the 3D image is changed.

The foregoing and/or other features or utilities may also be achieved by providing a computer-readable medium which is read by a computer to execute one of the above methods.

The foregoing and/or other features may be achieved by providing an apparatus to generate a mouse pointer which has a predetermined depth within a 3D image, the apparatus including a display unit which displays a 3D image thereon, a depth information extractor which extracts depth information of at least one object of the displayed 3D image, a location determiner which determines a location of a mouse pointer within the 3D image, and a depth processor which processes the mouse pointer to have a predetermined depth in the location determined by the location determined by using the depth information extracted by the depth information extractor.

The apparatus may further include an image converter which converts the mouse pointer into a 3D mouse pointer.

The depth information extractor may further include a map generator which generates a depth map of the at least one object within a 3D image space based on the extracted depth information.

The generated depth map may include a plurality of depth levels, and the apparatus may further include a storage unit which stores therein size information of the mouse pointer corresponding to the plurality of depth levels.

The depth processor may select one of the plurality of depth levels corresponding to the determined location of the mouse pointer, and may process the depth of the mouse pointer by adjusting the size of the mouse pointer corresponding to the selected depth level stored in the storage unit.

The apparatus may further include a rendering unit which renders the mouse pointer to have the predetermined depth.

The image converter may change a location or a direction of the mouse pointer corresponding to a changed viewing angle of a camera if the viewing angle of the camera of the 3D image is changed.

Features and/or utilities of the present general inventive concept may also be realized by an apparatus to generate a 3D pointer including a depth processor to determine a depth of the pointer based on location information of the pointer in a 3D image and depth information of the pointer, and a rendering unit to generate a 3D rendition of the pointer based on the location information and the determined depth of the pointer.

When a viewing angle of a viewing source of the 3D image changes, the rendering unit may change the 3D rendition of the pointer to correspond to the changed location

The rendering unit may change the 3D rendition of the pointer only when the location information falls within a predetermined range of location information in the 3D image.

The rendering unit may change the 3D rendition of the pointer by changing at least one of a size of the pointer, a height of the pointer, a width of the pointer, and a direction that the pointer faces.

The apparatus may further include a depth information extractor including a map generator to extract depth information of at least one object in the 3D image and to generate a depth map of the 3D image based on the extracted depth information, wherein the depth processor determines the depth of the pointer based on the depth map generated by the depth information extractor.

The 3D pointer may correspond to a cursor of at least one of a mouse, a track-ball, a touch-pad, and a stylus.

The apparatus may further include an electronic display unit, wherein the 3D image is an image displayed on the electronic display unit.

Features and/or utilities of the present general inventive concept may also be realized by a method of generating a 3D pointer in a 3D image, the method including obtaining location information of the pointer in the 3D image and depth information of the pointer, and rendering the pointer as a 3D object according to the obtained location information and depth information.

Obtaining the depth information may include obtaining depth information of at least one object in the 3D image, generating a depth map of the 3D image based on the depth information of the at least one object, and obtaining the depth information of the pointer based on the generated depth map.

The method may further include changing a location of a viewing source of the 3D image to change at least one of the location information and the depth information of the pointer relative to the viewing source, and changing the rendering of the pointer according to the changed at least one of the location information and the depth information.

Changing the rendering of the pointer may include changing at least one of a size of the pointer, height of the pointer, width of the pointer, and direction that the pointer faces.

The method may further include determining whether the changed at least one of the location information and depth information falls within a predetermined range, and changing the rendering of the pointer according to the changed at least one of the location information and depth information only when the changed at least one of the location information and depth information falls within the predetermined range.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates an apparatus to generate a mouse pointer according to an exemplary embodiment of the present general inventive concept;

FIG. 2 is a control block diagram of the apparatus to generate the mouse pointer according to an exemplary embodiment of the present general inventive concept;

FIGS. 3A to 3C illustrate a process of generating a mouse pointer having a predetermined depth in the apparatus to generate the mouse pointer according to an exemplary embodiment of the present general inventive concept;

FIGS. 4A to 4D illustrate examples of a three-dimensional mouse pointer which is generated by the apparatus to generate the mouse pointer according to an exemplary embodiment of the present general inventive concept;

FIGS. 5A to 5C illustrate an example of a three-dimensional mouse pointer which is generated by the apparatus to generate the mouse pointer according to the exemplary embodiment of the present general inventive concept, and has a predetermined depth and is displayed in a three-dimensional image;

FIG. 6 is a flowchart of a method of generating a mouse pointer having a predetermined depth in a three-dimensional image according to an exemplary embodiment of the present general inventive concept; and

FIGS. 7A to 7E illustrate displaying a 3D mouse pointer according to an embodiment of the present general inventive concept.

### DETAILED DESCRIPTION OF THE EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

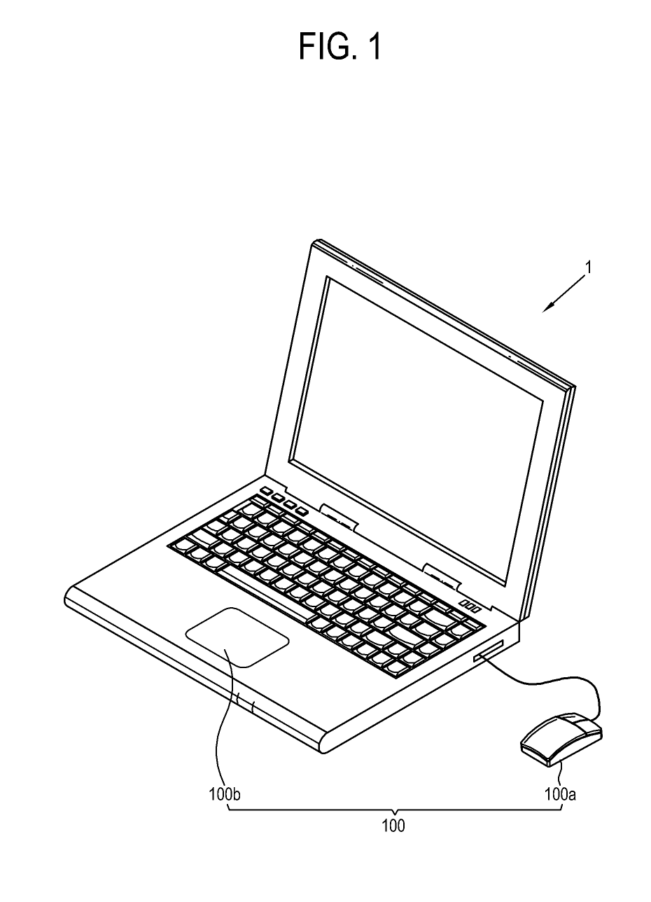

FIG. 1 illustrates an apparatus 1 that generates a mouse pointer according to an exemplary embodiment of the present general inventive concept.

The apparatus 1 to generate the mouse pointer may include any type of an electronic device having a pointing unit 100 including a mouse 100a and a touch pad 100b, and the apparatus 1 may be a desktop computer or a laptop computer, for example. If the apparatus 1 to generate the mouse pointer includes a personal computer (PC), it may also include other PCs such as a smart book, a mobile internet device (MID), a netbook as well as a typical PC. The mouse pointer may correspond to an input from a mouse 100a, as illustrated in FIG. 1, or any other pointing device, such as a trackball, touch-pad, stylus pen, or any other similar device capable of controlling a pointer on an electronic display. In other words, the mouse pointer is a displayed item on an electronic display that corresponds to a position and movement of a pointing device. As the pointing device moves, the mouse pointer may move on the display. The display may be a two- or three-dimensional display, and the mouse pointer may be displayed to move in two or three dimensions, accordingly.

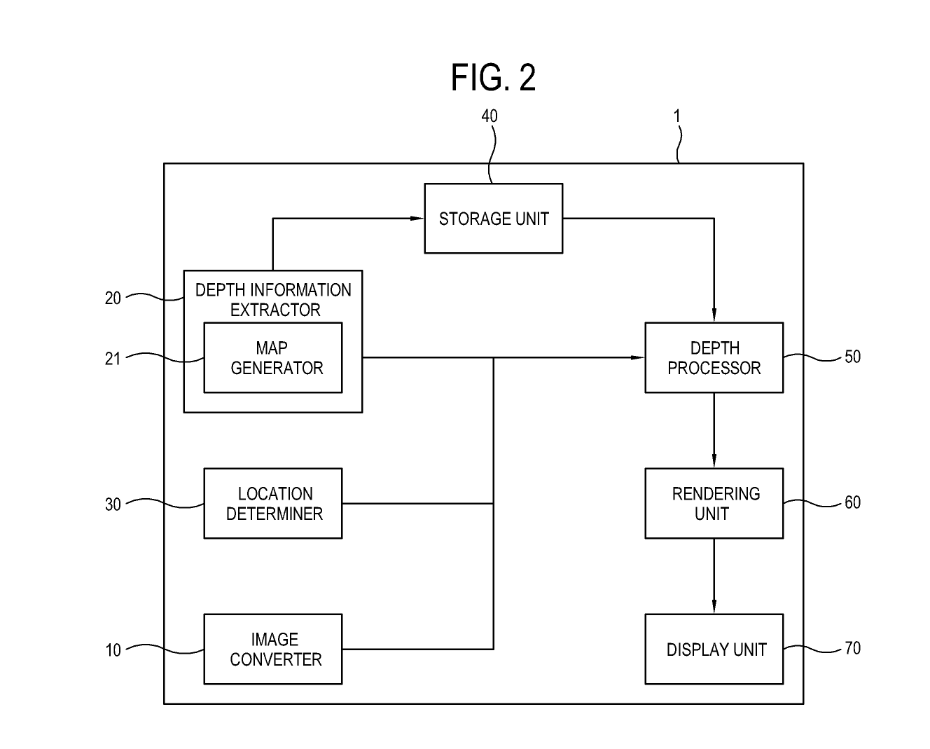

Referring to FIG. 2, if the apparatus 1 to generate the mouse pointer includes a computer system, it may include peripheral devices including a central processing unit (CPU) (not shown), a main memory (not shown), a memory controller hub (not shown), an I/O controller hub (ICH) (not shown), a graphic controller (not shown), a display unit 70, and a pointing unit 100. The CPU controls overall operations of the computer system and executes a computer program loaded on the main memory. To execute such computer program, the CPU may communicate with, and control, the MCH and the ICH. The main memory temporarily stores therein data relating to the operations of the CPU, including the computer program executed by the CPU. The main memory includes a volatile memory, e.g., a double-data-rate synchronous dynamic random access memory (DDR SDRAM). The graphic controller processes graphic data displayed on the display unit 70. The peripheral devices include various hardware, such as a hard disk drive, a flash memory, a CD-ROM, a DVD-ROM, a USB drive, a Bluetooth adaptor, a modem, a network adaptor, a sound card, a speaker, a microphone, a tablet, and a touch screen. The MCH interfaces reading and writing of data between the CPU and other elements, and the main memory. The ICH interfaces a communication between the CPU and the peripheral devices. The computer program which is executed by the CPU according to the present exemplary embodiment may include a basic input output system (BIOS), an operating system (OS) and an application. The BIOS may be stored in a BIOS ROM, a nonvolatile memory. The OS and the application may, for example, be stored in the HDD.

FIG. 2 is a control block diagram of the apparatus 1 to generate the mouse pointer according to an exemplary embodiment of the present general inventive concept.

The apparatus 1 to generate the mouse pointer includes an image converter 10, a depth information extractor 20, a location determiner 30, a storage unit 40, a depth processor 50, a rendering unit 60, and the display unit 70.

The image converter 10 may convert a mouse pointer into a three-dimensional (3D) mouse pointer. The mouse pointer may include a two-dimensional (2D) or 3D image. Upon setting by a user or displaying a 3D image, the image converter 10 may convert the mouse pointer from a 2D mouse pointer into a 3D mouse pointer. The image converter 10 may convert the 2D mouse pointer into a mouse pointer whose 3D coordinate values (x, y, and z) are recognized in a 3D plane.

Generally, the 2D mouse pointer may operate in a 2D plane (x, y). However, if a 3D mouse pointer is generated by the image converter 10, the mouse pointer itself becomes a 3D object in a 3D image, and 3D coordinates (x, y, and z) of the mouse pointer may be recognized in the 3D plane. Accordingly, the mouse pointer may have a predetermined depth according to the value z.

If a viewing angle of a camera with respect to a 3D image is changed, the image converter 10 may change a location and/or a direction of the mouse pointer corresponding to the changed viewing angle of the camera. That is, corresponding to the changed viewing angle, the mouse pointer may rotate and change its location and/or direction. Accordingly, the direction and size of the 3D mouse pointer may be determined according to the location viewed by the camera (the sight of the camera) in a 3D image displayed on the display unit 70. In the present specification and claims, the term “camera” refers to a viewing source, or a point of view from which a displayed image is viewed, and not necessarily a physical camera. For example, if the display includes an image as seen from a first angle, and a user scrolls the image to view the image from a different angle, the “camera,” or point of view of the image is adjusted, although no physical camera is used or moved.

The depth information extractor 20 extracts depth information of at least one object included in a predetermined 3D image. The 3D image may include at least one object or a plurality of objects. The depth information extractor 20 may extract depth information of the objects within the 3D image space. Accordingly, the depth information extractor 20 may extract coordinate values (x, y, and z) of the objects within the 3D image space.

A map generator 21 may generate a depth map of the at least one object within the 3D image space based on the depth information extracted by the depth information extractor 20.

The depth map may include a plurality of levels of depth, and may classify the value z of the at least one object extracted by the depth information extractor 20, according to the plurality of levels of depth. The generated depth map may be stored in the storage unit 40 (to be described later).

The location determiner 30 may determine a location of the mouse pointer within the 3D image. If a user sets or changes a location of the mouse pointer through the pointing unit 100, the location determiner 30 may determine the set or changed location of the mouse pointer within the 3D image.

The 3D mouse pointer itself which is generated by the image converter 10 is an object having location coordinates (x, y, and z).

One of the objects included in the 3D image, whose coordinate values (x and y) are the same as the coordinate values of the mouse pointer or are in the same scope as those of the mouse pointer may be selected. Then, a value z of the selected object may be compared to a value z of the mouse pointer. If the value z of the selected object is different from the value z of the mouse pointer, the value z of the mouse pointer may be set as the value z of the selected object. Then, the 3D coordinate value of the mouse pointer pointed to by the pointing unit 100 is determined. The determined coordinate value z may be used to set the size of the mouse pointer corresponding to the depth level stored in the storage unit 40 to thereby process the depth of the mouse pointer by the depth processor 50 (to be described later).

The storage unit 40 may store therein a depth map of at least one object which is generated on the basis of depth information of at least one object extracted by the depth information extractor 20 and the depth information generated by the map generator 21.

The depth map which is generated by the map generator 21 includes a plurality of depth levels. The storage unit 40 may store therein size information of the mouse pointer corresponding to the plurality of depth levels.

The storage unit 40 may include a nonvolatile memory such as a read-only memory (ROM) or a flash memory, or a volatile memory such as a random access memory (RAM).

The depth processor 50 may process the depth of the mouse pointer in the location determined by the location determiner 30 by using the depth information extracted by the depth information extractor 20.

The location determiner 30 determines the location coordinate values (x and y) of the mouse pointer set by the pointing unit 100 within the 3D image. An object which has the same coordinate values (x and y) as those of the mouse pointer or has coordinate values in the same predetermined scope as those of the mouse pointer is selected by using the depth information extracted by the depth information extractor 20, and a depth level of the selected object is determined by using the depth map generated by the map generator 21 and stored in the storage unit 40. The depth processor 50 may determine that the set depth level is the depth level of the mouse pointer, and process the depth of the mouse pointer to have the set depth level.

The depth of the mouse pointer may be processed by adjusting the size of the mouse pointer with the size information of the mouse pointer corresponding to the plurality of depth levels stored in the storage unit 40.

The rendering unit 60 may render the mouse pointer processed to have a predetermined depth by the depth processor 50 and display the mouse pointer on the display unit 70 (to be described later). Accordingly, the mouse pointer which has the predetermined depth may be accurately expressed its shape and ratio by perspective views in the 3D image, or expressed in shade and color, or in a texture or pattern by the rendering unit 60.

The display unit 70 may display therein an image corresponding to a predetermined 2D or 3D image signal. If the 3D image is displayed, the mouse pointer which is rendered by the rendering unit 60 is also displayed on the display unit 70.

The display unit 70 includes a display panel (not shown) to display the image thereon. The display panel may include a liquid crystal display (LCD) panel including a liquid crystal layer, an organic light emitting diode (OLED) panel including an organic light emitting layer, or a plasma display panel (PDP).

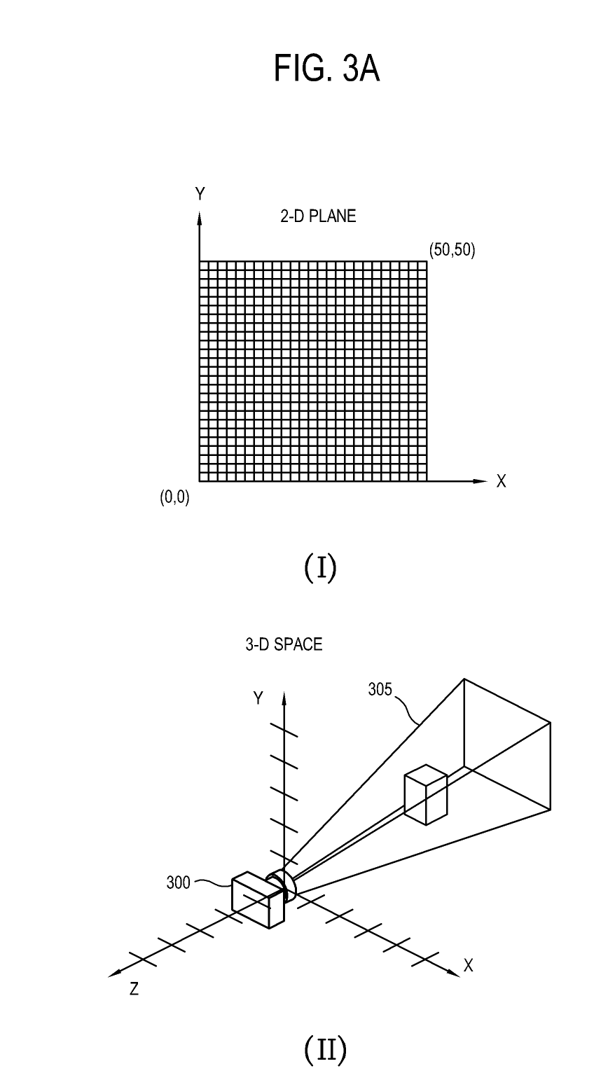

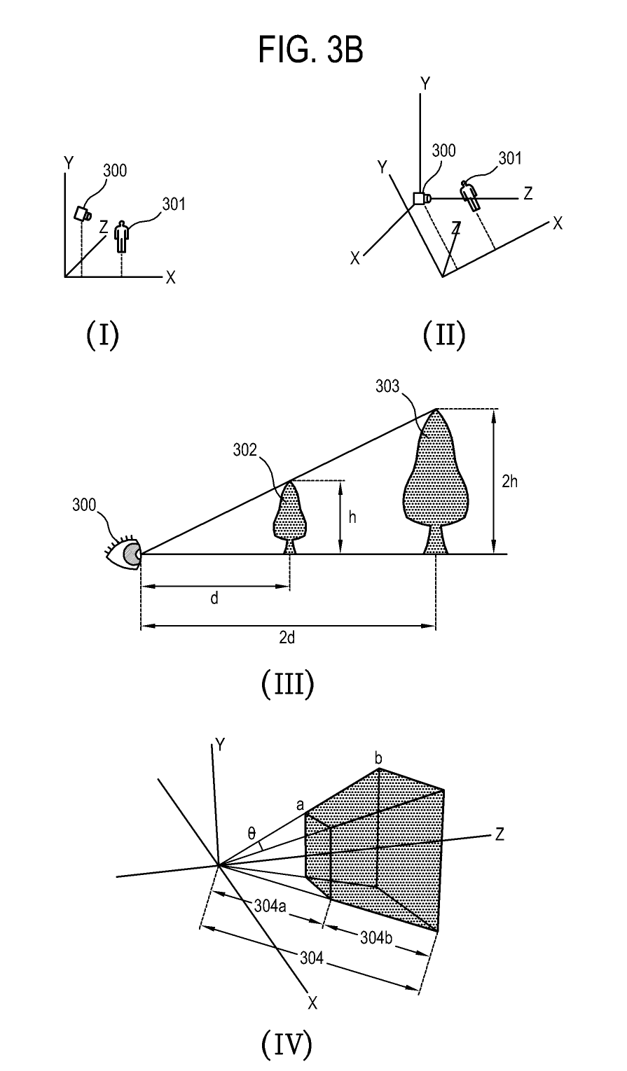

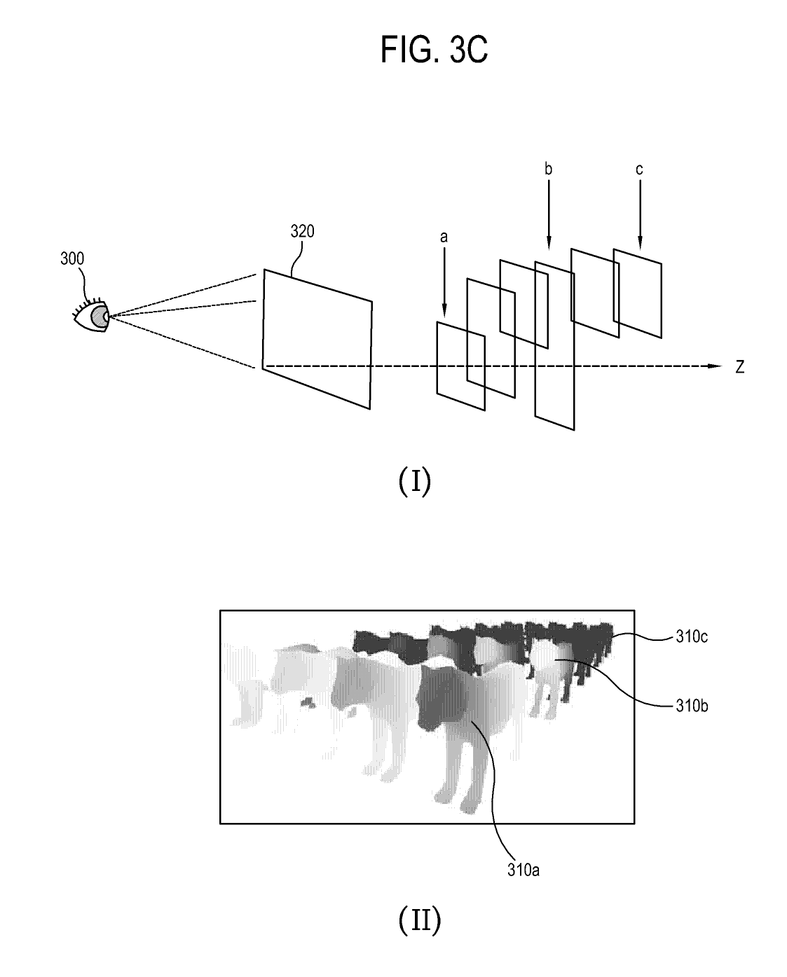

FIG. 3 illustrates a process of generating a mouse pointer having a predetermined depth in the apparatus) for generating the mouse pointer according to an exemplary embodiment of the present general inventive concept.

An example of the apparatus 1 for generating the mouse pointer according to an exemplary embodiment of the present general inventive concept is a mouse pointer in a 3D image such as a game in a computer system including a mouse pointing unit.

FIG. 3A illustrates an example of a 3D image conversion of the mouse pointer in the apparatus 1 to generate the mouse pointer according to an exemplary embodiment of the present general inventive concept.

Upon selecting a setting by a user or displaying a 3D image, the image converter 10 of the apparatus 1 to generate the mouse pointer converts the mouse pointer into a 3D mouse pointer.

The apparatus 1 determines whether a current image displayed on the display unit 70 is 2D or 3D before converting the mouse pointer. If the image is a 3D image, the apparatus 1 determines a version of an application programming interface (API) executed by the apparatus 1 to generate a 3D mouse pointer. Generally, the API may include open graphics library (OpenGL) or DirectX. The OpenGL is a standard API to define a 2D and 3D graphic image while DirectX is an API generating and managing a graphic image and a multimedia effect in Windows OS.

A general mouse pointer is 2D in a 2D or 3D image. The 2D mouse pointer operates only in a 2D plane (x and y) according to the API of Win32 oS (refer to I in FIG. 3A). However, according to an exemplary embodiment of the present general inventive concept, the mouse pointer is converted into a 3D mouse pointer by using the determined 3D API by the image converter 10, and the 3D coordinate values (x, y, and z) of the 3D mouse pointer may be recognized (refer to II in FIG. 3A).

The 3D mouse pointer which is generated by the image converter 10 may have a depth value z as an object within the 3D image.

FIG. 3B illustrates an example of a conversion of the coordinates of a 3D mouse pointer in the apparatus 1 to generate the mouse pointer according to an exemplary embodiment of the present general inventive concept.

As shown in FIG. 3A(II), the 3D mouse pointer which is generated by the image converter 10 may be expressed at various angles according to a viewing angle of a camera 300 of a 3D image 305 in a 3D space. The mouse pointer goes through the following processes to be expressed corresponding to the viewing angle of the camera of the 3D image.

First, the 3D mouse pointer undergoes a world transformation as shown in (I) in FIG. 3B.

The world transformation means the process of transforming the coordinate values of the 3D mouse pointer from a model space (where definite points are defined on the basis of a local starting point of the model) to a world space (where definite points are defined on the basis of common starting points of all objects within a 3D image). The world transformation may include movement, rotation, change in size, and scaling, or a combination thereof. In FIG. 3B(I), element 300 represents a camera or point of view of the 3D displayed image, and element 301 represents an object in the 3D image, while coordinates X, Y, and Z represent width, height, and depth dimensions, respectively.

Second, the 3D mouse pointer which has undergone the world transformation undergoes a view transformation as shown in (II) in FIG. 3B.

That is, the coordinates of the mouse pointer which has undergone the world transformation are moved and/or rotated so that a view point of the camera 300 of the 3D image displayed on the display unit 70 becomes a starting point. More specifically, a camera 300 is defined in the 3D world space, and the view transformation of the coordinates of the 3D mouse pointer is performed according to the coordinate and a viewing direction of the camera 300. The location, direction, or size of the 3D mouse pointer may be determined according to a viewing location of the camera of a 3D image. The location, direction, or size of the 3D mouse pointer may be determined by using the following member variables.

TABLE 1
Member variables of 3D mouse pointer

| Member variables | Description |
|---|---|
| m_vEye | Camera location |
| m_vLookAt | Camera view point |
| m_fCameraYawAngle | Camera yaw angle |
| m_fCameraPitchAngle | Camera pitch angle |
| m_fFOV | Field of view |
| m_fAspect | Aspect ratio |
| m_fNearPlane | Plane closest to view |
| | frustum |
| m_fFarPlane | Plane farthest from view |
| | frustum |
| m_fRotationScaler | Adjustment of scaling when |
| | camera rotates |

When the view transformation is performed, a light source defined in the world space is also transformed to the view space, and the shading of the 3D mouse pointer may be added as necessary.

Third, the 3D mouse pointer which has undergone the view transformation undergoes a projection transformation as shown in (III) in FIG. 3B.

The projection transformation is a process of expressing a perspective of the 3D mouse pointer within the 3D image. The size of the mouse pointer is changed depending on the distance of objects and thus is given perspective within the 3D image. For example, FIG. 3B(III) illustrates a first object 302 that has a height h when located a first distance d from the camera 300, and a second object 303 that has a height 2 h located a second distance 2 d from the camera 300. In the projection transformation process, it is determined that from the perspective of the camera, the first and second objects 302 and 303 have the same displayed height.

Fourth, a view frustum 304b is generated as shown in (IV) in FIG. 3B. In other words, a pyramid-shaped viewing area 304 may be calculated based on the viewing angle θ of the camera (located at the origin in FIG. 3B(IV), and a displayed portion 304b of the pyramid 304 may be identified and separated from a non-displayed portion 304a to generate the view frustum 304b.

When the 3D mouse pointer is given perspective by the projection transformation, the view frustum having a view volume corresponding to the given perspective is generated.

In addition, a windows system message may be processed for the 3D mouse pointer.

That is, a mouse button message may be processed to move the 3D mouse pointer within the 3D image space. An example of the above processing is shown in Table 2 below.

TABLE 2
Windows message processing

| Windows message | Description |
|---|---|
| WM_RBUTTONDOWN | Upon pressing the right |
| | button of the mouse, a value |
| | of a current cursor is |
| | captured. |
| WM_RBUTTONUP | Upon pressing the left |
| | button of the mouse, a |
| | current storage is released. |
| WM_MOUSEMOVE & | Upon dragging while the |
| WM_RBUTTONDOWN | right button of the mouse is |
| | pressed, the view point of |
| | the mouse is changed. |

FIG. 3C illustrates an example of a depth map of the apparatus 1 to generate the mouse pointer according to an exemplary embodiment of the present general inventive concept.

If the mouse pointer is changed from a 2D mouse pointer to a 3D mouse pointer as in FIG. 3A, the value z is recognized in the 3D image space. The value z is a factor used to express the distance (perspective) of 3D objects as shown in (I) in FIG. 3C. Depth values (values z) of an object a which is closest to a user, an object c farthest from a user and an object b located between the objects a and c range between zero and one. For example, the object a which is closest to a user may have a value z of zero, and the object c which is farthest from a user may have a value z of one.

Thus, if the map generator 21 generates a depth map having a plurality of depth levels by using the depth information extracted by the depth information extractor 20, the size information of the mouse pointer in a predetermined scope corresponding to the plurality of depth levels may also be generated and stored in the storage unit 40.

In FIG. 3C, element 300 represents the camera or point-of-view of the display, element 320 represents a display screen, and objects a, b, and c represent objects that are displayed to have different apparent depths with respect to the display screen 320.

That is, as shown in (II) in FIG. 3C, information on the size of the object a with a value z of zero may be generated and stored at the highest level and information on the size of the object c with a value z of one may be generated and stored at the lowest level. In FIG. 3C(II), objects 310a, 310b, and 310c represent objects having different apparent depths and may correspond to objects a, b, and c of FIG. 3C(I), for example.

The 3D mouse pointer which is generated by the image converter 10 has the 3D location coordinate values (x, y, and z) as an object. The values (x and y) of the mouse pointer which is pointed by the pointing unit 100 are determined. One of a plurality of objects having the same values (x, y) as those of the mouse pointer or values in the same scope as those of the mouse pointer in the 3D image is selected. The value z of the selected object is compared to the value z of the mouse pointer. Then, the location of the mouse pointer and the location of the object may be determined. The storage unit 40 stores therein the size information of the mouse pointer corresponding to one of the plurality of depth levels, to which the value z of the selected object belongs. That is, the value z may be set from zero to one. If the value z is close to zero, the mouse pointer is determined to be close to the camera in the 3D image and the size of the mouse pointer is adjusted to be larger. If the value z is close to one, the mouse pointer is determined to be far from the camera in the 3D image and the size of the mouse pointer may be adjusted to be smaller. Accordingly, the size information of the mouse pointer with respect to the depth level of the value z of the selected object is used to adjust the size of the mouse pointer by the depth processor 50 to thereby generate a mouse pointer having a predetermined depth. The generated 3D mouse pointer may be rendered by the rendering unit 60 and displayed on the display unit 70.

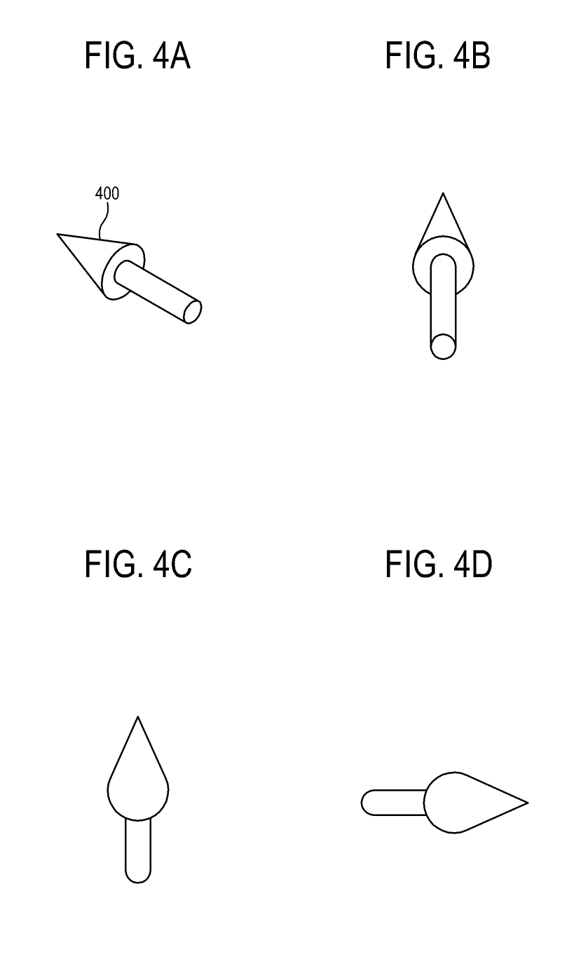

FIGS. 4A to 4D illustrate examples of a 3D mouse pointer 400 which is generated by the apparatus 1 to generate the mouse pointer according to an exemplary embodiment of the present general inventive concept.

While in some instances, a conventional computer system may generate a 3D mouse pointer, the 3D mouse pointer which is generated by the conventional computer system does not rotate corresponding to the view point of the camera as in the present general inventive concept.

Meanwhile, a 3D mouse pointer which is generated by the apparatus 1 to generate the mouse pointer according to an exemplary embodiment of the present general inventive concept may be changed corresponding to the change of the view point of the camera and displayed.

As shown therein, if a 3D mouse pointer 400 moves in an oblique direction (refer to FIG. 4A), if the mouse pointer moves in a direction in which an object in an image has a large depth value (refer FIG. 4B), if the mouse pointer moves upwards (refer to FIG. 4C), or if the mouse pointer moves to the right side (refer to FIG. 4D), the 3D mouse pointer also changes corresponding to the changed view point of the camera in the 3D image and a user may enjoy an enhanced 3D effect.

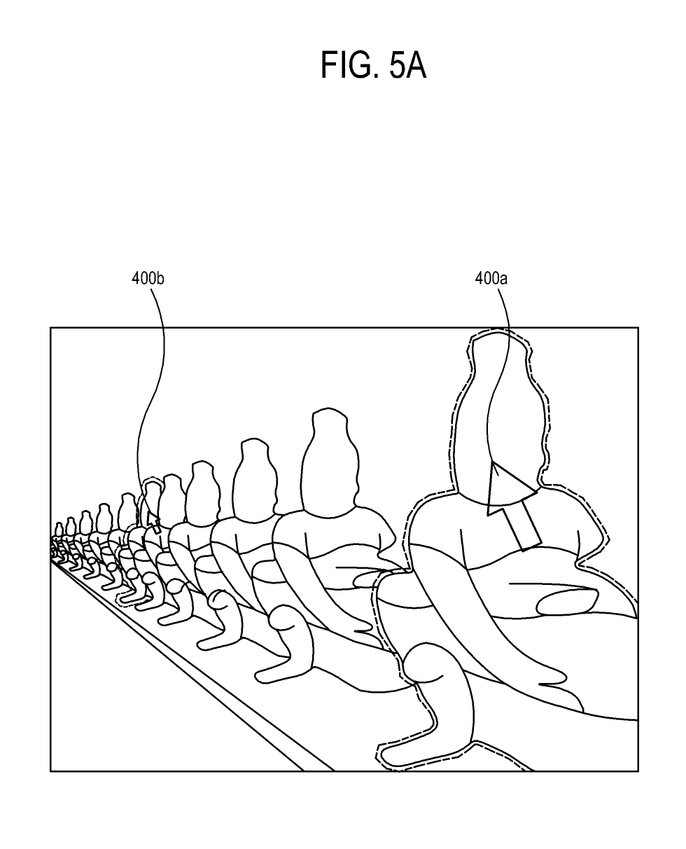

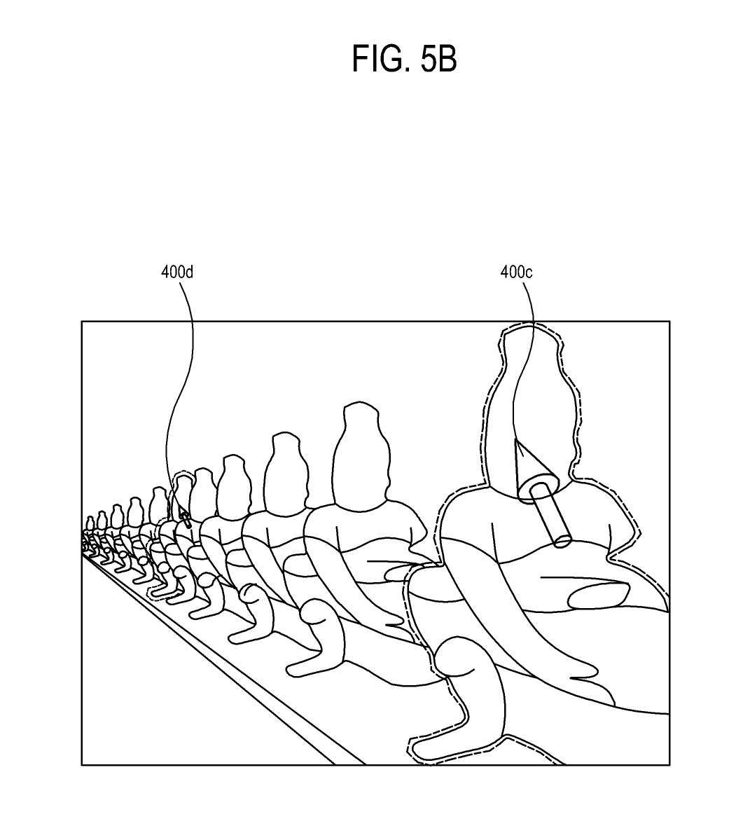

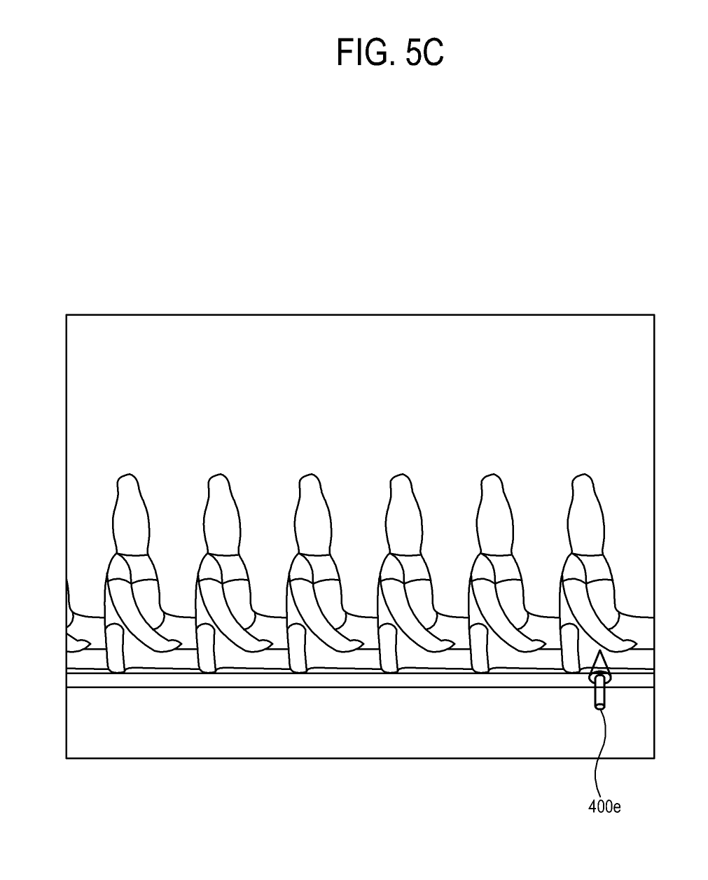

FIGS. 5A and 5B illustrate an example of a 3D mouse pointer that has a predetermined depth and is generated by the apparatus 1 to generate the mouse pointer according to an exemplary embodiment of the present general inventive concept, and is displayed in a 3D image.

FIG. 5A illustrates a mouse pointer which is 2D, but has a predetermined depth in a 3D image.

If a mouse pointer which is pointed by the pointing unit 100 is 2D, it has values (x and y). Based on the values (x and y), the location of the mouse pointer may be determined in the 3D image. An object which has the same values (x and y) as those of the mouse pointer or the values (x and y) in the same scope as those of the mouse pointer in the 3D image is selected, and the size information of the mouse pointer stored in the storage unit 40 corresponding to the depth value of the object extracted by the depth information extractor 20 is used so that the 2D mouse pointer has a predetermined depth.

As shown therein, even if the mouse pointer is 2D, a mouse pointer having different depths may be displayed according to the change of the location. If the mouse pointer 400a, having a value z close to zero, is near the camera, has a larger size than the mouse pointer 400b, having a value z is close to one and far from the camera, to thereby express the depth of the mouse pointer.

FIG. 5B illustrates a 3D mouse pointer which is expressed to have a predetermined depth in a 3D image.

As shown in FIG. 5B, the depth of the 3D mouse pointer is expressed as larger when the mouse pointer 400c is close to the camera and has a value of z close to zero compared to when the mouse pointer 400d is far from the camera and has a value of z close to one.

FIG. 5C illustrates a 3D mouse pointer which changes in shape corresponding to a changed field of view of the camera in a 3D image.

FIG. 5C illustrates an image when a field of view of the camera is changed compared to the images in FIGS. 5A and 5B. As shown in FIG. 5C, the 3D mouse pointer 400e is changed in shape to correspond to the change in direction of the camera with respect to FIG. 5B. As the location or direction of the 3D mouse pointer changes corresponding to the changed field of view of the camera, a user may enjoy an enhanced 3D effect.

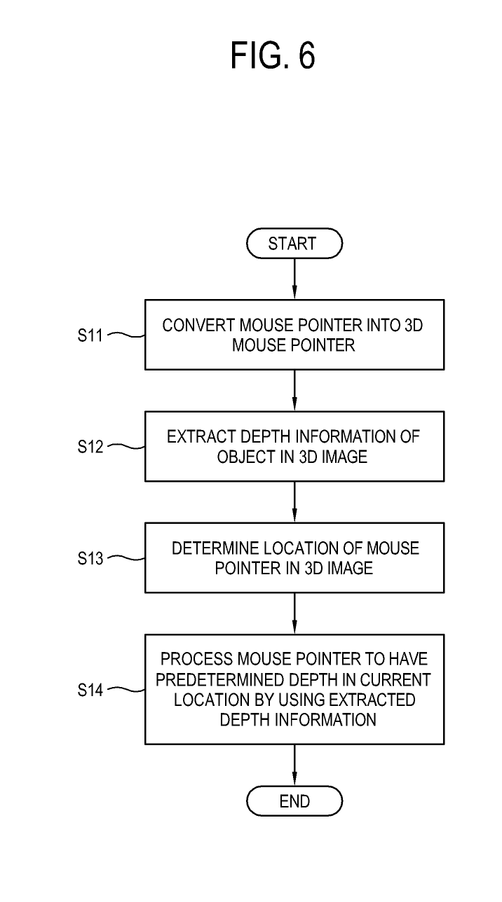

FIG. 6 is a flowchart of a method for generating a mouse pointer which has a predetermined depth in a 3D image according to the exemplary embodiment of the present general inventive concept.

Upon a user's selection or upon displaying a 3D image, the mouse pointer is changed to a 3D mouse pointer in operation S11.

The depth information of the at least one object of the 3D image is extracted in operation S12. The process of generating the depth map including the plurality of depth levels based on the extracted depth information may be performed additionally.

The location of the changed mouse pointer is determined in the 3D image in operation S13. Based on the generated depth map, the depth value of the mouse pointer may be compared to the depth value of the object corresponding to the location of the mouse pointer to thereby determine the location of the mouse pointer and the object.

If the location of the mouse pointer is determined, the size information of the mouse pointer stored in advance corresponding to the plurality of depth levels may be used in operation S14 to adjust the size of the mouse pointer corresponding to the value z in the location of the mouse pointer to thereby generate a mouse pointer having a predetermined depth. The generated mouse pointer may be rendered and displayed on the display unit 70.

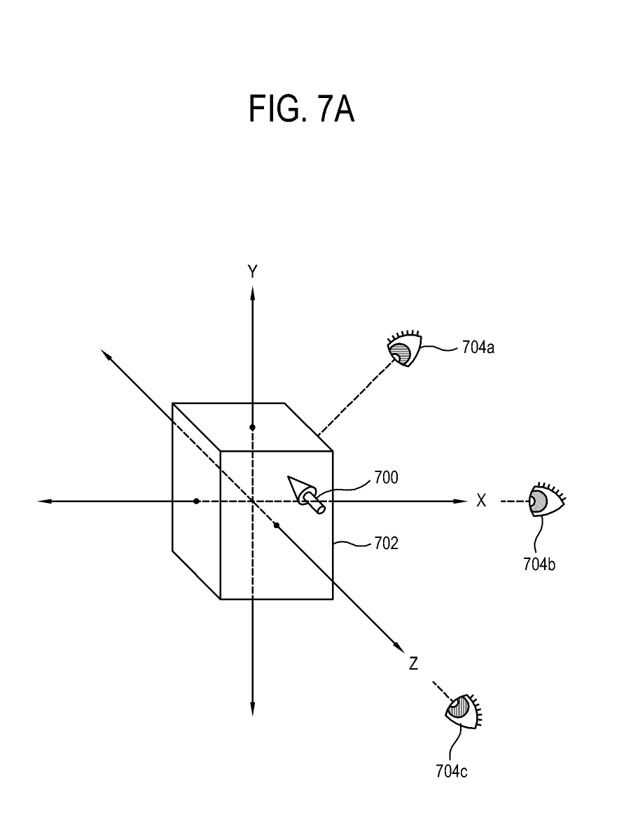

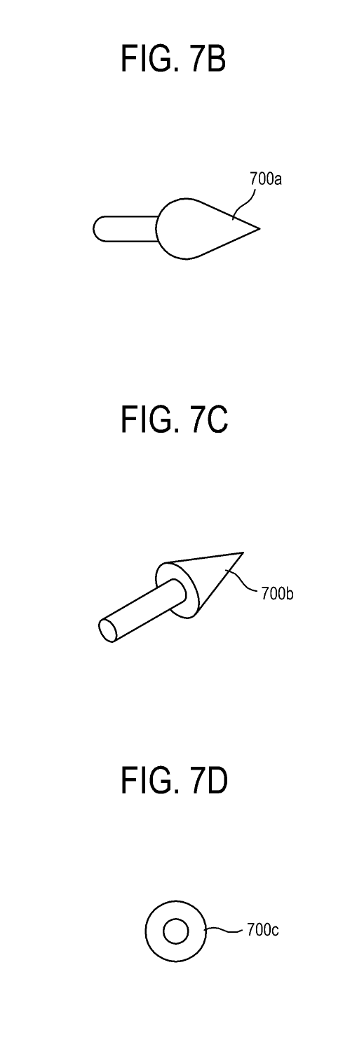

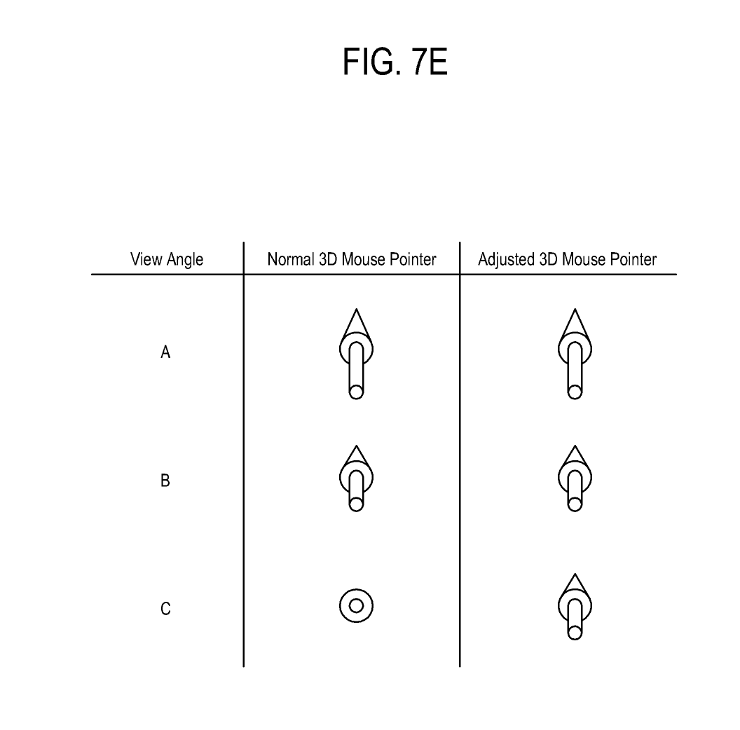

FIGS. 7A to 7E illustrate examples of adjusting a 3D mouse pointer according to an embodiment of the present general inventive concept. In FIG. 7A, a mouse pointer 700 is located next to a 3D object 702. A user or processor executing a program may adjust a camera angle to correspond to locations 704a, 704b, and 704c, for example. As the camera angle is adjusted, the mouse pointer 700 may be adjusted as illustrated in FIGS. 7B to 7D to correspond to the spatial dimensions of the object 702 relative to the camera. For example, the camera 704a may result in the mouse pointer 700a of FIG. 7B, the camera 704b may result in the mouse pointer 700b of FIG. 7C, and the camera 704c may result in the mouse pointer 700c of FIG. 7D.

Since the mouse pointer 700c may be unclear to a user, the mouse pointer may be modified to always maintain at least a minimum angle with respect to the camera. For example, FIG. 7E illustrates a mouse pointer 700 at three separate angles A, B, and C relative to a camera. When it is determined that the angle of the camera generates a mouse pointer having a pointing portion that is hidden from a viewer, the mouse pointer 700 may be adjusted to have a minimum angle so that the pointing portion is visible, while maintaining a 3D effect of the mouse pointer that changes as the viewing angle of the camera changes.

While one example of adjusting the angle of the mouse pointer has been presented, the present general inventive concept encompasses any modification of the angle of the 3D mouse pointer. For example, the mouse pointer may always be displayed as having a pointer directed towards a top of the screen, and the direction that the pointer faces in the X direction or width direction of the screen, as well as the length and size of the pointer, may be adjusted to correspond to the 3D image displayed on the screen.

Even if a user changes the location of the mouse pointer by using the pointing unit 100, the mouse pointer having a predetermined depth at the changed location is generated and displayed, and a user may enjoy an enhanced 3D effect.

The system according to the present general inventive concept may be embodied as a code read by a computer on a computer-readable medium. The processes in FIG. 6 may be performed by a bus coupled to each unit shown in FIG. 2 and by at least one processor coupled to the bus. The system according to the present general inventive concept may include a memory which is coupled to at least one processor to perform the foregoing operations by being coupled to the bus to store a command, the received or generated message. The computer-readable medium may be any type of data recording media, including ROM, RAM, CD-ROM, a magnetic tape, a floppy disk, or an optical data storage. The computer-readable medium may be distributed in a computer system connected in a network. For example, the computer-readable medium may include one or more servers or processors connected via a wired or wireless connection with antenna, cables, or other wires.

As described above, an apparatus and a method of generating a mouse pointer according to the present general inventive concept provides a mouse pointer having a predetermined depth in a 3D image space and allows a user to enjoy an enhanced 3D effect.

Although a few exemplary embodiments have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A method of generating a mouse pointer which has a predetermined depth within a three-dimensional (3D) image, the method comprising:
extracting depth information of at least one object of a 3D image;
determining a location of a mouse pointer within the 3D image; and
processing the mouse pointer to have a predetermined depth in the determined location by using the extracted depth information.

2. The method according to claim 1, further comprising converting the mouse pointer into a 3D mouse pointer.

3. The method according to claim 1, further comprising generating a depth map of the at least one object within a 3D image space based on the extracted depth information.

4. The method according to claim 3, wherein the generated depth map comprises a plurality of depth levels, and the processing the depth of the mouse pointer comprises selecting one of the plurality of depth levels corresponding to the determined location of the mouse pointer and processing the mouse pointer to have a depth corresponding to the selected depth level.

5. The method according to claim 4, wherein the processing the depth of the mouse pointer comprises processing the mouse pointer to have the predetermined depth by adjusting a size of the mouse pointer.

6. The method according to claim 1, further comprising rendering the mouse pointer which is processed to have the predetermined depth.

7. The method according to claim 2, wherein the converting the mouse pointer further comprises converting a location or a direction of the mouse pointer corresponding to a changed viewing angle of a camera if the viewing angle of the camera of the 3D image is changed.

8. A non-transitory computer-readable medium which is read by a computer to execute a method of generating a mouse pointer which has a predetermined depth within a three-dimensional (3D) image, the method comprising:
extracting depth information of at least one object of a 3D image;
determining a location of a mouse pointer within the 3D image; and
processing the mouse pointer to have a predetermined depth in the determined location by using the extracted depth information.

9. An apparatus to generate a mouse pointer which has a predetermined depth within a 3D image, the apparatus comprising:
a display unit which displays a 3D image thereon;
a depth information extractor which extracts depth information of at least one object of the displayed 3D image;
a location determiner which determines a location of a mouse pointer within the 3D image; and
a depth processor which processes the mouse pointer to have a predetermined depth in the location determined by the location determined by using the depth information extracted by the depth information extractor.

10. The apparatus according to claim 9, further comprising an image converter which converts the mouse pointer into a 3D mouse pointer.

11. The apparatus according to claim 9, wherein the depth information extractor further comprises a map generator which generates a depth map of the at least one object within a 3D image space based on the extracted depth information.

12. The apparatus according to claim 11, wherein the generated depth map comprises a plurality of depth levels, the apparatus further comprising a storage unit which stores therein size information of the mouse pointer corresponding to the plurality of depth levels.

13. The apparatus according to claim 12, wherein the depth processor selects one of the plurality of depth levels corresponding to the determined location of the mouse pointer, and processes the depth of the mouse pointer by adjusting the size of the mouse pointer corresponding to the selected depth level stored in the storage unit.

14. The apparatus according to claim 9, further comprising a rendering unit which renders the mouse pointer to have the predetermined depth.

15. The apparatus according to claim 10, wherein the image converter changes a location or a direction of the mouse pointer corresponding to a changed viewing angle of a camera if the viewing angle of the camera of the 3D image is changed.

16. An apparatus to generate a 3D pointer, comprising:
a depth processor to determine a depth of the pointer based on location information of the pointer in a 3D image and depth information of the pointer; and
a rendering unit to generate a 3D rendition of the pointer based on the location information and the determined depth of the pointer.

17. The apparatus of claim 16, wherein when a viewing angle of a viewing source of the 3D image changes, the rendering unit changes the 3D rendition of the pointer to correspond to the changed location information relative to the changed viewing angle and the determined depth.

18. The apparatus of claim 17, wherein the rendering unit changes the 3D rendition of the pointer only when the location information falls within a predetermined range of location information in the 3D image.

19. The apparatus of claim 17, wherein the rendering unit changes the 3D rendition of the pointer by changing at least one of a size of the pointer, a height of the pointer, a width of the pointer, and a direction that the pointer faces.

20. The apparatus of claim 16, further comprising:
a depth information extractor including a map generator to extract depth information of at least one object in the 3D image and to generate a depth map of the 3D image based on the extracted depth information,
wherein the depth processor determines the depth of the pointer based on the depth map generated by the depth information extractor.

21. The apparatus of claim 16, wherein the 3D pointer corresponds to a cursor of at least one of a mouse, a track-ball, a touch-pad, and a stylus.

22. The apparatus of claim 16, further comprising an electronic display unit,
wherein the 3D image is an image displayed on the electronic display unit.

23. A method of generating a 3D pointer in a 3D image, the method comprising:
obtaining location information of the pointer in the 3D image and depth information of the pointer; and
rendering the pointer as a 3D object according to the obtained location information and depth information.

24. The method of claim 23, wherein obtaining the depth information comprises:
obtaining depth information of at least one object in the 3D image;
generating a depth map of the 3D image based on the depth information of the at least one object; and
obtaining the depth information of the pointer based on the generated depth map.

25. The method of claim 23, further comprising:
changing a location of a viewing source of the 3D image to change at least one of the location information and the depth information of the pointer relative to the viewing source; and
changing the rendering of the pointer according to the changed at least one of the location information and the depth information.

26. The method of claim 25, wherein changing the rendering of the pointer includes changing at least one of a size of the pointer, height of the pointer, width of the pointer, and direction that the pointer faces.

27. The method of claim 25, further comprising:
determining whether the changed at least one of the location information and depth information falls within a predetermined range; and
changing the rendering of the pointer according to the changed at least one of the location information and depth information only when the changed at least one of the location information and depth information falls within the predetermined range.
